(19) United States
(12) Patent Application Publication
(10) Pub. No.: US 2011/0244933 A1
(43) Pub. Date: Oct. 6, 2011

(54) ELECTRONIC DEVICE AND METHOD FOR SIMULATING BASKETBALL GAMES USING THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/825,354

(22) Filed: Jun. 29, 2010

(30) Foreign Application Priority Data
Apr. 2, 2010 (TW) 99110474

(51) Int. Cl. A63F 9/24; A63F 13/00

(52) U.S. Cl. 463/4; 463/30; 463/43

(57) ABSTRACT

An electronic device and method for simulating basketball games includes storing original wave data groups of a plurality of standard basketball actions in a storage system, and constructing a coordinate system based on the electronic device. In response to simulating the basketball action by a user holding the electronic device, movement data of the electronic device is detected using an accelerometer. The movement data is converted into wave data to compare with the original wave data groups. In response to determining a matched original wave data group, a prompt message including a name of a standard basketball action corresponding to the matched original wave data group is displayed on a display of the electronic device.

### BACKGROUND

1. Technical Field

Embodiments of the present disclosure relate to simulation technology, and more particularly to an electronic device and a method for simulating basketball games using the electronic device.

2. Description of Related Art

Many people like to play basketball. However, because of a limitation of basketball courts, people cannot play the basketball anywhere. Basketball simulation games are provided for players to play through computers, where the players play the basketball simulation games using keyboards or mouse of the computers.

### BRIEF DESCRIPTION OF THE DRAWINGS

FIG. 1 is a block diagram of one embodiment of an electronic device.

FIG. 2 is a schematic diagram of one embodiment of a three-dimension coordinate system on the electronic device of FIG. 1.

FIG. 3 is a schematic diagram of one embodiment of a basketball dribbling action.

FIG. 4 is a schematic diagram of one embodiment of movements of the electronic device of FIG. 1.

FIG. 5 is a schematic diagram of one embodiment of an original wave data group.

FIG. 6 is a flowchart of one embodiment of a method for creating template data using the electronic device of FIG. 1.

FIG. 7 is a flowchart of one embodiment of a method for simulating basketball games using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, Java, C, or Assembly, for example. One or more software instructions in the modules may be embedded in firmware, such as an erasable programmable read only memory (EPROM). It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system.

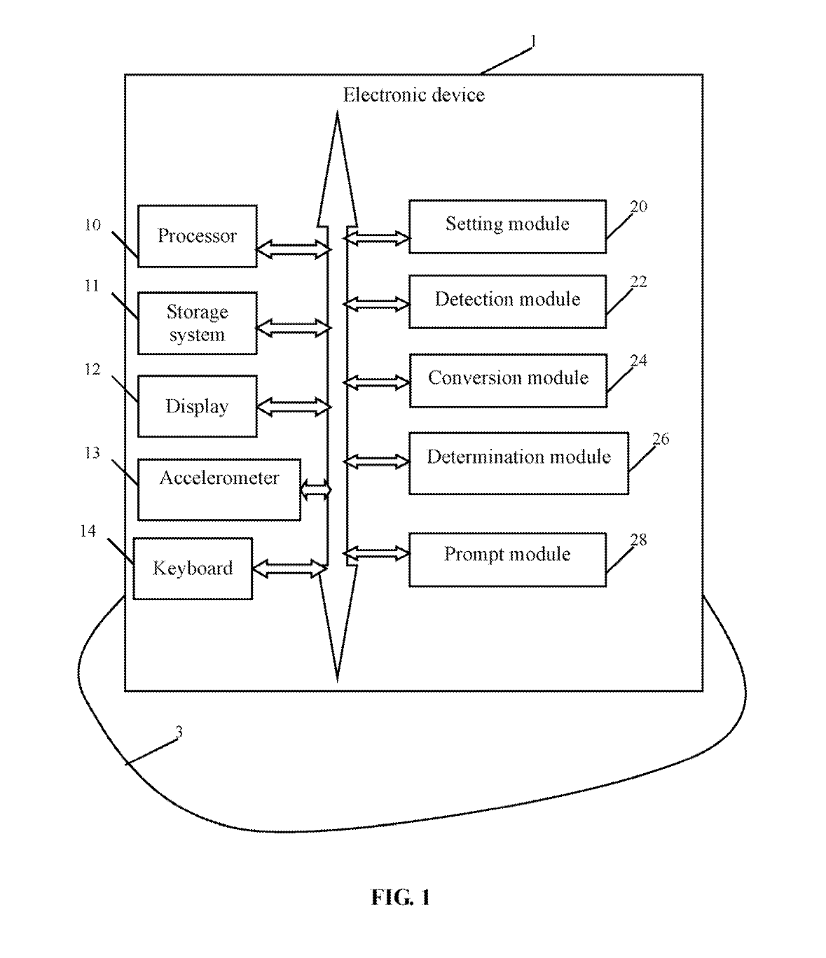

FIG. 1 is a block diagram of one embodiment of an electronic device 1. The electronic device 1 may be held by a user to simulate a basketball action (e.g., shoot a basket, dribbling), record relevant data of the simulated basketball action, and determine if the simulated basketball action is correct according to prestored data. Detailed descriptions are provided below.

In some embodiments, the electronic device 1 may be a mobile phone, a personal digital assistant, or any other computing device. The electronic device 1 includes a processor 10, a storage system 11, a display 12, an accelerometer 13, and a keyboard 14. The processor 10 executes one or more computerized operations of the electronic device 1 and other applications, to provide functions of the electronic device 1. The storage system 11 stores one or more programs, such as programs of the operating system, other applications of the electronic device 1, and various kinds of data, such as images, E-mails, for example. In one embodiment, the electronic device 1 may be a mobile phone, and the storage system 11 may include a memory of the electronic device 1 and/or an external storage card, such as a memory stick, a smart media card, a compact flash card, or any other type of memory card.

The display 12 may display visible data, such as, messages, videos, for example. The display 12 may be a liquid crystal display (LCD) or a light-emitting diode (LED). The accelerometer 13 can be used to measure orientation, acceleration, vibration or shock of the electronic device 1. The keyboard 14 includes various keys to be pressed by the user to input data or invoke a function of the electronic device 1.

In some embodiments, in order to avoid accidental throwing or dropping of the electronic device 1 when simulating the basketball action, the electronic device 1 further includes a wrist strap 3. The wrist strap 3 may tie the electronic device 1 to a wrist of the user. The wrist strap 3 may be removed from the electronic device 1.

In addition, the electronic device 1 further includes a setting module 20, a detection module 22, a conversion module 24, a determination module 26, and a prompt module 28. The modules 20, 22, 24, 26 and 28 may include one or more computerized codes to be executed by the processor 10 to perform one or more operations of the electronic device 1. Details of these operations will be provided below.

Template data of the electronic device 1 needs to be created and stored in the storage system 11. In some embodiments, a basketball athlete may hold the electronic device 1 to simulate a plurality of standard basketball actions, such as shooting a basket, or basketball dribbling, for example. In other embodiments, the user may hold the electronic device 1 to perform the standard basketball actions himself, to create the template data of the electronic device 1. Detailed descriptions of the template data are provided below.

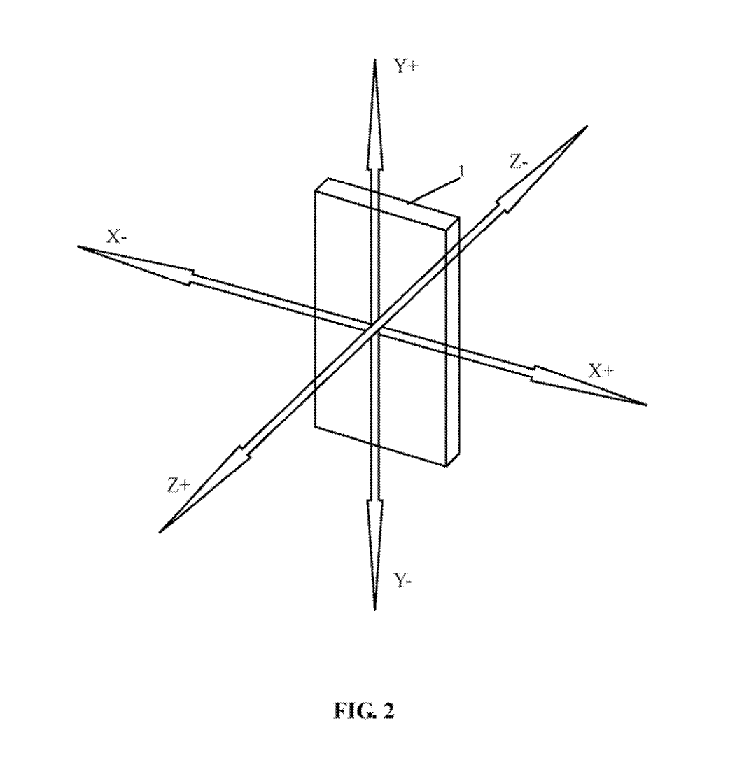

As shown in FIG. 2, The setting module 20 constructs a 3D coordinate system based on the center of the electronic device 1. The setting module 20 also sets a hotkey on the keyboard 14 to enable the accelerometer 13 to detect movements of the electronic device 1. For example, the hotkey may be a “#” key on the keyboard 14, or a character string (e.g., “123#”) that can be entered with the keyboard 14.

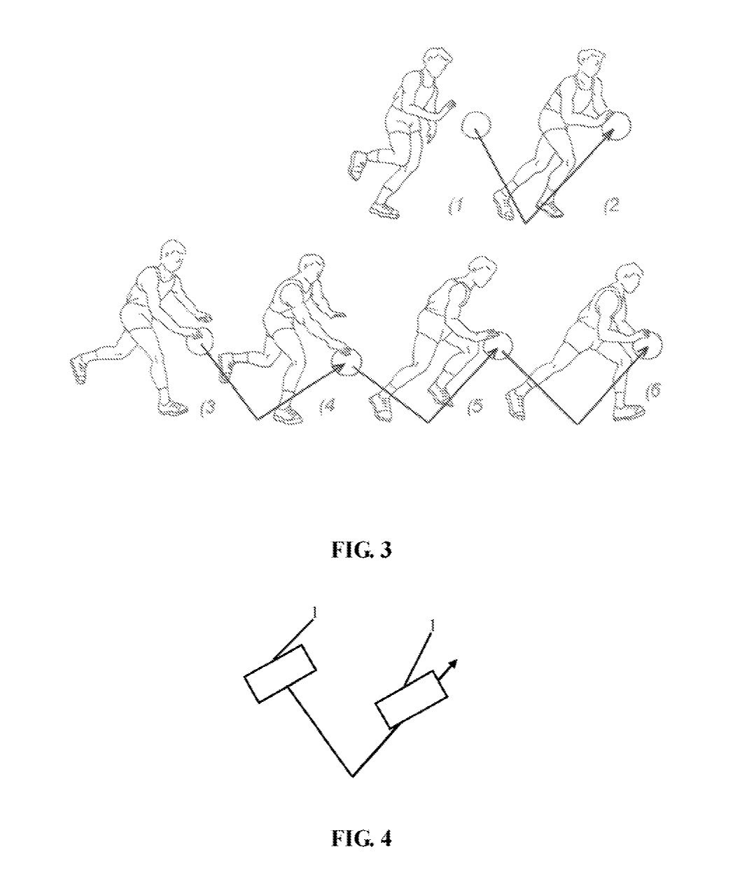

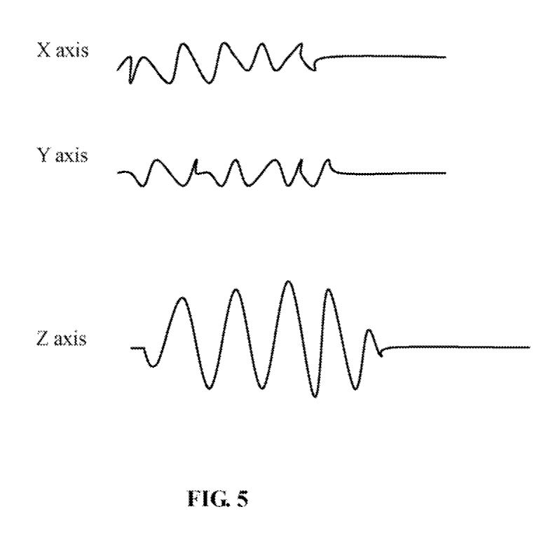

Under the condition that the hotkey is pressed, the accelerometer 13 is enabled to detect movements of the electronic device 1. In response to executing one of the standard basketball actions by the user holding the electronic device 1, the detection module 22 detects original movement data of the electronic device 1, based on the coordinate system using the accelerometer 13. FIG. 3 is a schematic diagram of the basketball athlete executes a basketball dribbling action. In FIG. 4, a movement direction of the electronic device 1 is shown when the basketball athlete holds the electronic device 1 and simulates the standard basketball action.

In some embodiments, the original movement data of the electronic device 1 are coordinate variables of the electronic device 1 based on the coordinate system. For example, an X coordinate of the electronic device 1 may change from “0” to “3,” and then change from “3” to “−2” when the electronic device 1 being held to simulate the standard basketball action.

The conversion module 24 converts the original movement data into original wave data, and stores the original wave data as an original wave data group in the storage system 11. A schematic diagram of the original wave data group is shown in FIG. 5. The original wave data group is regarded as the template data of the electronic device 1.

The setting module 20 names the original wave data group with a name of the standard basketball action in response to receiving a user input through the keyboard 14. For example, the name may be “shoot a basket.” By utilizing above mentioned modules, a plurality of original wave data groups may be created and stored as the template data of the electronic device 1 in the storage system 11.

In response to storing the template data of the electronic device 1, the electronic device 1 may be held by the user to simulate a basketball action. The setting module 20 further sets a standard rate to determine if the basketball action is simulated correctly. For example, the standard rate may be 85%. Detailed descriptions are provided below.

In response to simulating the basketball action by the user holding the electronic device 1, the detection module 22 detects movement data of the electronic device 1 based on the coordinate system using the accelerometer 13.

The conversion module 24 converts the movement data into wave data. The determination module 26 calculates a match rate of the converted wave data and each of the original wave data groups. In some embodiments, the determination module 26 may compare the converted wave data with each of the wave data groups using sharp context arithmetic or any template comparison technology.

The determination module 26 determines if there is a match rate is more than the standard rate. If a match rate is more than the standard rate, the determination module 26 determines a matched original wave data group corresponding to the match rate being more than the standard rate. If no match rate is more than the standard rate, the determination module 26 determines that the simulated basketball action fails.

The determination module 26 further calculates a difference between the converted wave data and the matched original wave data group. In some embodiments, the difference between the converted wave data and the matched original wave data group is calculated according to coordinate differences of the converted wave data and the matched original wave data group. The determination module 26 further determines a simulation result according to the difference between the converted wave data and the matched original wave data group. The simulation result represents an accuracy of the simulated basketball action.

For example, a match rate between the converted wave data and the matched original wave data group is 86%. That is, the converted wave data still has a difference with the matched original wave data group. The determination module 26 determines the difference as follows. X axis coordinates of the matched original wave data group begins toward the positive direction of the X axis, whereas X axis coordinates of the converted wave data begins toward negative direction of the X axis first. If the simulated basketball action is “shooting a basket,” then a simulation result is determined as “shooting the basketball leaning to the left” according to the difference as mentioned above.

In some embodiments, the prompt module 28 displays a prompt message including a name of a standard basketball action corresponding to the matched original wave data group and the simulation result on the display 12. For example, the prompt message may be “shooting the basketball leaning to the left.” In other embodiments, the prompt module 28 may output the prompt message audibly through a speaker of the electronic device 1.

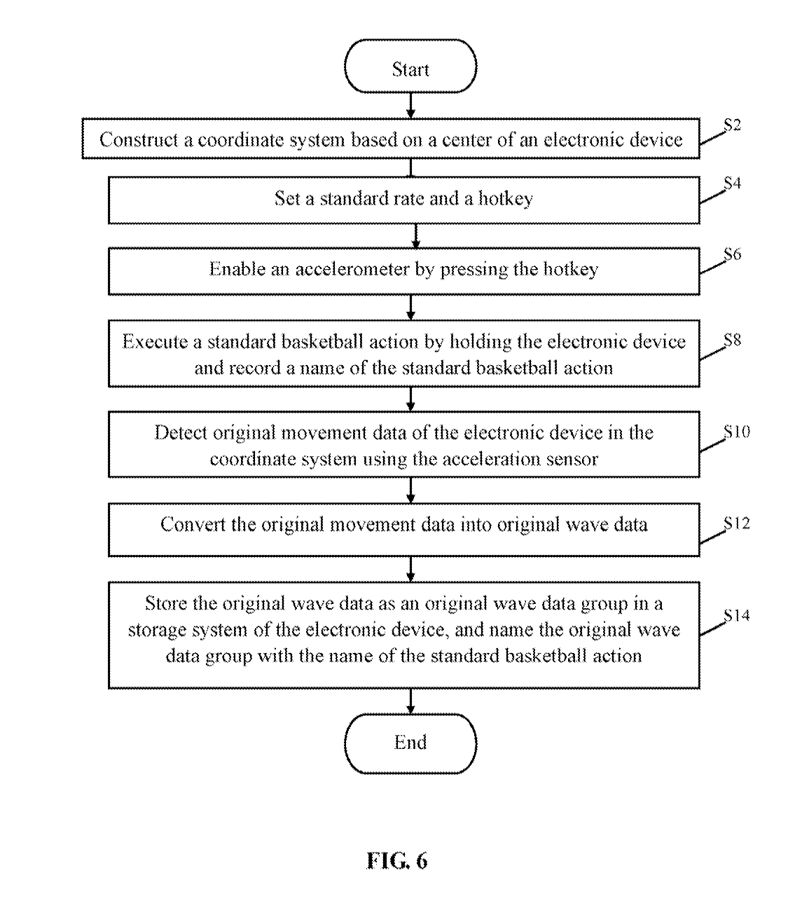

FIG. 6 is a flowchart of one embodiment of a method for creating the template data using the electronic device 1 of FIG. 1. Depending on the embodiment, additional blocks may be added, others removed, and the ordering of the blocks may be replaced.

In block S2, the setting module 20 constructs a coordinate system based on the center of the electronic device 1.

In block S4, the setting module 20 sets a standard rate, and sets a hotkey on the keyboard 14 to enable the accelerometer 13 to detect movements of the electronic device 1. As mentioned above, the hotkey may be a “#” key on the keyboard 14, or a character string (e.g., “123#”) that can be entered through the keyboard 14.

In block S6, the accelerometer 13 is enabled by pressing the hotkey.

In block S8, the electronic device 1 is held by a basketball athlete or other proper people to execute a standard basketball action, and the setting module 20 records a name of the standard basketball action in response to receiving a user input.

In block S10, the detection module 22 detects original movement data of the electronic device 1 based on the coordinate system using the accelerometer 13. As mentioned above, the original movement data of the electronic device 1 are coordinate variables of the electronic device 1 on the coordinate system.

In block S12, the conversion module 24 converts the original movement data into original wave data. An example of the original wave data is shown in FIG. 5.

In block S14, the conversion module 24 stores the original wave data as an original wave data group in the storage system 11, and the setting module 20 names the original wave data group with the name of the standard basketball action. The original wave data group is regarded as the template data of the electronic device 1.

By repeating blocks S2 to S14, a plurality of standard basketball actions may be executed to create a plurality of original wave data groups.

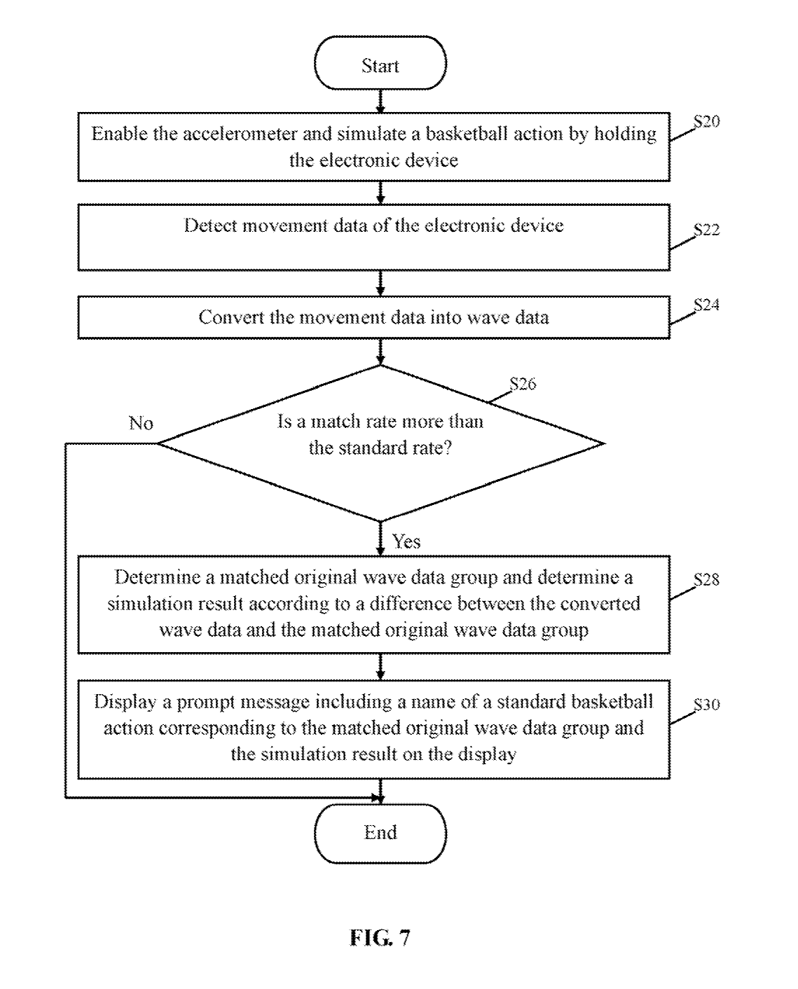

FIG. 7 is a flowchart of one embodiment of a method for simulating basketball games using the electronic device 1 of FIG. 1. Depending on the embodiment, additional blocks may be added, others removed, and the ordering of the blocks may be replaced.

In block S20, the accelerometer 13 is enabled by pressing the hotkey, and the user holds the electronic device 1 to simulate a basketball action.

In block S22, the detection module 22 detects movement data of the electronic device 1 based on the coordinate system using the accelerometer 13.

In block S24, the conversion module 24 converts the movement data into wave data.

In block S26, the determination module 26 calculates a match rate of the converted wave data and each of the original wave data groups, and determines if there is a match rate is more than the standard rate.

If no match rate is more than the standard rate, the determination module 26 determines that the simulated basketball action fails, and the procedure ends.

If the match rate is more than the standard rate, in block S28, the determination module 26 determines a matched original wave data group corresponding to the match rate being more than the standard rate. The determination module 26 further calculates a difference between the converted wave data and the matched original wave data group, and determines a simulation result according to the difference.

In block S30, the prompt module 28 displays a prompt message including a name of a standard basketball action corresponding to the matched original wave data group and the simulation result on the display 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for simulating basketball games using an electronic device, the method comprising:
storing original wave data groups of a plurality of standard basketball actions in a storage system of the electronic device;
naming each of the original wave data groups with a name of each of the plurality of standard basketball actions;
constructing a coordinate system based on a center of the electronic device, and setting a standard rate to determine if a basketball action is simulated correctly;
in response to simulating the basketball action by a user holding the electronic device, detecting movement data of the electronic device based on the coordinate system using an accelerometer of the electronic device;
converting the movement data into wave data;
determining a matched original wave data group in response to determining that a match rate of the converted wave data and the matched original wave data group is more than the standard rate;
determining a simulation result according to a difference between the converted wave data and the matched original wave data group; and
displaying a prompt message comprising a name of a standard basketball action corresponding to the matched original wave data group and the simulation result on a display of the electronic device.

2. The method according to claim 1, further comprising:
determining that the simulated basketball action fails in response to determining that no match rate of the converted wave data and each of the original wave data groups is more than the standard rate.

3. The method according to claim 1, wherein the difference between the converted wave data and the matched original wave data group is calculated according to coordinate differences of the converted wave data and the matched original wave data group.

4. The method according to claim 1, wherein the simulation result represents an accuracy of the simulated basketball action.

5. The method according to claim 1, wherein the step of storing original wave data groups of a plurality of standard basketball actions by holding the electronic device comprises:
in response to executing one of the plurality of standard basketball actions by the user holding the electronic device, detecting original movement data of the electronic device based on the coordinate system using the accelerometer;
converting the original movement data into original wave data; and
storing the original wave data as one of the original wave data group.

6. The method according to claim 1, further comprising:
setting a hotkey on a keyboard of the electronic device to enable the accelerometer to detect the movement data of the electronic device.

7. An electronic device, comprising:
a display;
an accelerometer;
a storage system to store original wave data groups of a plurality of standard basketball actions;
at least one processor; and
one or more programs stored in the storage system and being executable by the at least one processor, the one or more programs comprising:
a setting module operable to name each of the original wave data groups with a name of each of the plurality of standard basketball actions, construct a coordinate system based on a center of the electronic device, and set a standard rate to determine if a basketball action is simulated correctly;
a detection module operable to detect movement data of the electronic device based on the coordinate system using the accelerometer in response to simulating the basketball action by a user holding the electronic device;
a conversion module operable to convert the movement data into wave data;
a determination module operable to determine a matched original wave data group in response to determining that a match rate of the converted wave data and the matched original wave data group is more than the standard rate, and determine a simulation result according to a difference between the converted wave data and the matched original wave data group; and
a prompt module operable to display a prompt message comprising a name of a standard basketball action corresponding to the matched original wave data group and the simulation result on the display.

8. The electronic device according to claim 7, wherein the determination module is further operable to determine that the simulated basketball action fails in response to determining that no match rate of the converted wave data and each of the original wave data groups is more than the standard rate.

9. The electronic device according to claim 7, wherein the difference between the converted wave data and the matched original wave data group is calculated according to coordinate differences of the converted wave data and the matched original wave data group.

10. The electronic device according to claim 7, wherein the simulation result represents an accuracy of the simulated basketball action.

11. The electronic device according to claim 7, wherein:
the detection module is further operable to detect original movement data of the electronic device based on the coordinate system using the accelerometer in response to executing one of the plurality of standard basketball actions by the user holding the electronic device;
the conversion module is further operable to convert the original movement data into original wave data, and store the original wave data as one of the original wave data group in the storage system.

12. The electronic device according to claim 7, wherein the setting module is further operable to set a hotkey on a keyboard of the electronic device to enable the accelerometer to detect the movement data of the electronic device.

13. A storage medium storing a set of instructions, the set of instructions capable of being executed by a processor to perform a method for simulating basketball games using an electronic device, the method comprising:
storing original wave data groups of a plurality of standard basketball actions in a storage system of the electronic device;
naming each of the original wave data groups with a name of each of the plurality of standard basketball actions;
constructing a coordinate system based on a center of the electronic device, and setting a standard rate to determine if a basketball action is simulated correctly;
in response to simulating the basketball action by a user holding the electronic device, detecting movement data of the electronic device based on the coordinate system using an accelerometer of the electronic device;
converting the movement data into wave data;
determining a matched original wave data group in response to determining that a match rate of the converted wave data and the matched original wave data group is more than the standard rate;
determining a simulation result according to a difference between the converted wave data and the matched original wave data group; and
displaying a prompt message comprising a name of a standard basketball action corresponding to the matched original wave data group and the simulation result on a display of the electronic device.

14. The storage medium as claimed in claim 13, wherein the method further comprises:
determining that the simulated basketball action fails in response to determining that no match rate of the converted wave data and each of the original wave data groups is more than the standard rate.

15. The storage medium as claimed in claim 13, wherein the difference between the converted wave data and the matched original wave data group is calculated according to coordinate differences of the converted wave data and the matched original wave data group.

16. The storage medium as claimed in claim 13, wherein the simulation result represents an accuracy of the simulated basketball action.

17. The storage medium as claimed in claim 13, wherein the step of storing original wave data groups of a plurality of standard basketball actions by holding the electronic device comprises:
in response to executing one of the plurality of standard basketball actions by the user holding the electronic device, detecting original movement data of the electronic device based on the coordinate system using the accelerometer;
converting the original movement data into original wave data; and
storing the original wave data as one of the original wave data group.

18. The storage medium as claimed in claim 13, wherein the method further comprises:
setting a hotkey on a keyboard of the electronic device to enable the accelerometer to detect the movement data of the electronic device.
